(19) United States
(12) Patent Application Publication
(10) Pub. No.: US 2022/0342441 A1
(43) Pub. Date: Oct. 27, 2022

(54) DISPLAY DEVICE

(71) Applicant: Funai Electric Co., Ltd., Osaka (JP)

(72) Inventors: Takumi HAYASHI, Osaka (JP); Terutsugu NAKANO, Osaka (JP)

(21) Appl. No.: 17/708,509

(22) Filed: Mar. 30, 2022

(30) Foreign Application Priority Data
Apr. 26, 2021 (JP) 2021-74389

(51) Int. Cl. G06F 1/16

(52) U.S. Cl. CPC G06F 1/1607

(57) ABSTRACT

A display device comprises a display device main body that includes a display, a main body support member that supports a back surface of the display device main body, a cover member that covers the main body support member so as to form a space extending from one end portion of the cover member, which is closer to the back surface than the other end portion, to the other end portion between the main body support member and the cover member and allow wiring connected to the display device main body to pass through the space, and at least one first vibration absorbing member that is provided between the main body support member and the cover member to suppress transmission of vibration between the main body support member and the cover member.

### CROSS-REFERENCE TO RELATED APPLICATIONS

This application claims priority to Japanese Patent Application No. 2021-74389 filed in Japan on Apr. 26, 2021. The entire disclosure of Japanese Patent Application No. 2021-74389 is hereby incorporated herein by reference.

### BACKGROUND

### Field of the Invention

This invention generally relates to a display device. More specifically, this invention relates to a display device comprising a display device main body, a main body support member supporting the display device main body, and a cover member.

### Background Information

Conventionally, a display device comprising a display device main body, a main body support member, and a cover member is known (see, for example, Japanese Laid-Open Patent Application Publication No. H11-249577 (Patent Literature 1)).

Considering the appearance of the back surface of the display device main body in Patent Literature 1 above, a stand (a main body support member) is provided with a cover (a cover member) that covers the entire back surface of the stand. The stand leads cables coming out of the back surface of the display device main body downward from an upper end portion of the back surface of the stand. The cover covers the cable located at a back surface portion of the stand. Hooks are provided on the back surface of the stand. An attachment piece is provided on a surface of the cover on the stand side. The cover is attached to the hook provided to the stand via the attachment piece.

### SUMMARY

Although not described in Patent Literature 1, when a speaker is provided to the display device main body, the sound output from this speaker is transmitted to the stand via a frame of the display device, causing the stand to vibrate. This vibration of the stand may cause interference noise (chattering noise) due to the interference of the contact portions between the stand and the cover. Therefore, it is desired to suppress the generation of the interference noise (chattering noise) between the stand (the main body support member) and the cover (the cover member).

One object is to provide a display device capable of suppressing the generation of interference noise between the main body support member and the cover member.

In view of the state of the known technology, a display device according to a first aspect of this disclosure comprises a display device main body including a display, a main body support member that supports a back surface of the display device main body, a cover member that covers the main body support member so as to form a space extending from one end portion of the cover member, which is closer to the back surface than the other end portion to the other end portion between the main body support member and the cover member and allow wiring connected to the display device main body to pass through the space, and at least one first vibration absorbing member that is provided between the main body support member and the cover member to suppress transmission of vibration between the main body support member and the cover member.

### BRIEF DESCRIPTION OF THE DRAWINGS

FIG. 1 is a rear perspective view of a display device according to a first embodiment, as viewed from a back surface side.

FIG. 2 is a side elevational view of the display device according to the first embodiment.

FIG. 3 is an enlarged rear perspective view of the display device according to the first embodiment, illustrating a display device main body and a main body support member in a state in which a cover member is detached.

FIG. 4 is a normal view of the cover member according to the first embodiment, illustrating a first surface of the cover member.

FIG. 5 is a side view of a first vibration absorbing member according to the first embodiment.

FIG. 6 is an enlarged cross-sectional view of the display device according to the first embodiment, illustrating a fixing structure of the cover member and the main body support member via the first vibration absorbing member.

FIG. 7 is an enlarged perspective view of the display device according to the first embodiment, illustrating an engagement piece.

FIG. 8 is an enlarged cross-sectional view of the display device according to the first embodiment, illustrating an engagement structure between the cover member and a rear cover via the engagement piece.

FIG. 9 is an enlarged rear perspective view of a display device according to a second embodiment, illustrating a display device main body and a main body support member in a state in which a cover member is detached.

FIG. 10 is a normal view of the cover member according to the second embodiment, illustrating a first surface of the cover member.

FIG. 11 is a normal view of a cover member according to a modification example, illustrating a second surface of the cover member to which a speaker device is attached.

FIG. 12 is a normal view of a cover member according to another modification example, illustrating a first surface of the cover member to which a storage device is attached.

FIG. 13 is a schematic diagram of a cover member according to another modification example, illustrating an attachment and detachment of a storage device relative to the cover member to which the storage device is attached.

FIG. 14 is a normal view of a cover member according to another modification example, illustrating a first surface of the cover member to which a light source is attached.

FIG. 15 is a normal view of the cover member shown in FIG. 14, illustrating a second surface of the cover member to which the light source is attached.

FIG. 16 is a side elevational view of a display device with the cover member shown in FIGS. 14 and 15.

FIG. 17 is a schematic diagram showing an example of a setting screen for lighting control of the light source attached to the cover member shown in FIGS. 14 and 15.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

### First Embodiment

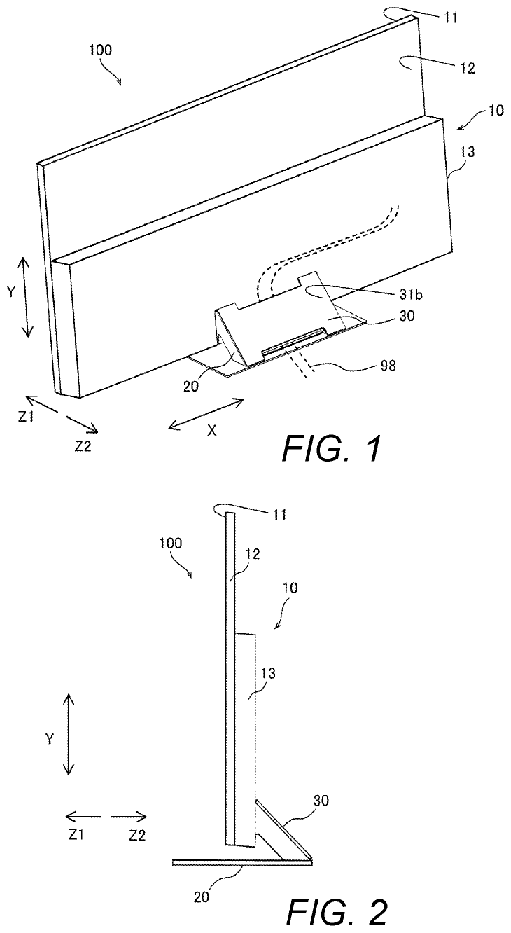

Referring to FIGS. 1 to 8, the configuration of a display device 100 according to a first embodiment of the disclosure will be described. In the drawings, the left and right direction (the horizontal direction) when the display device 100 is viewed from the front side (the front surface side) is referred to as an X-direction. The up and down direction (the vertical direction) is referred to as a Y direction. The direction connecting the front side and the rear side (the back surface side) of the display device 100 is referred to as a Z direction. With the Z direction, the direction toward the front side of the display device 100 is referred to as a Z1 direction, and the direction toward the rear side of the display device 100 is referred to as a Z2 direction.

As shown in FIGS. 1 and 2, the display device 100 according to the first embodiment has a display device main body 10, a main body support member 20, and a cover member 30.

### (Configuration of Display Device Main Body)

The display device main body 10 includes a display 11, a rear frame 12, and a rear cover 13.

The display 11 is disposed on the frontmost side of the display device 100. The display 11 is, for example, a liquid crystal panel.

The rear frame 12 is arranged to cover the rear side of the display 11 and supports the display 11. The rear frame 12 is made, for example, of a metal plate.

The rear cover 13 is arranged to cover a portion of the rear frame 12. The rear cover 13 is attached and fixed to a surface of the rear frame 12 on the opposite side from the display 11. The rear cover 13 is provided with a plurality of engagement holes 14 with which a plurality of engagement pieces 34 of the cover member 30 are engaged, as described below (see FIG. 4). In the illustrated embodiment, two engagement holes 14 are formed so that they are aligned relative to each other in the X direction.

### (Configuration of Main Body Support Member)

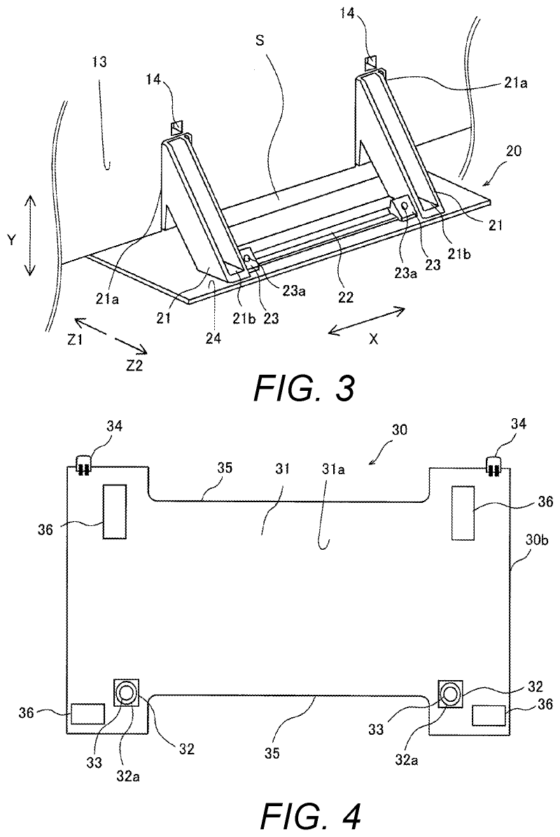

As shown in FIG. 3, the main body support member 20 includes a pair of support portions 21, a connection portion 22, a plurality of (two in FIG. 3) fitting portions 23 and a base portion 24.

The support portions 21 support the rear frame 12 of the display device main body 10 at end portions in the Z1 direction. The support portions 21 have display device attachment portions 21a that are attached to and fixed to the rear frame 12 of the display device main body 10 at one ends thereof. The support portions 21 are attached to the rear frame 12 at the display device attachment portions 21 with fixing members (not shown), such as screws, and support the display device main body 10. The support portions 21 are connected to the base portion 24 at end portions in the Z2 direction. The support portions 21 have base portion attachment portions 21b that are attached to and fixed to the base portion 24. The support portions 21 are attached to and fixed to the base portion 24 at the base portion attachment portions 21b with fixing members (not shown), such as screws.

The support portions 21 are inclined diagonally downward from the display device attachment portions 21a formed at the one ends toward the base portion attachment portions 21b formed at the other ends. In the illustrated embodiment, A pair of the support portions 21 are provided in the X direction. Thus, in the illustrated embodiment, the main body support member 20 includes the support portions 21 that extend downward as moving away from the back surface of the display device main body 10. Also, as described later, the cover member 30 is attached to the main body support member 20 (via first vibration absorbing members 33) such that the cover member 30 is oriented along the support portions 21.

The connection portion 22 connects the other ends (the end portions in the Z2 direction) of the support portions 21 with each other.

The fitting portions 23 are provided at the other ends (the end portions in the Z2 direction) of the support portions 21, respectively. The fitting portions 23 are provided adjacent to opposite surfaces of the support portions 21, respectively. The fitting portions 23 are configured to be able to fit with the first vibration absorbing members 33 provided to the cover member 30, which will be described below. The fitting portions 23 have, for example, first fitting holes 23a to which the first vibration absorbing members 33 are fitted, respectively.

The base portion 24 fixes the base portion attachment portions 21b of the support portions 21 to one surface of the base portion 24 via fixing members (not shown), such as screws. The base portion 24 is a planar member.

### (Configuration of Cover Member)

As shown in FIG. 4, the cover member 30 includes a cover member main body 31, a plurality of (two in FIG. 4) first vibration absorbing member fixing portions 32, a plurality of (two in FIG. 4) the first vibration absorbing members 33, a plurality of (two in FIG. 4) the engagement pieces 34, a plurality of (two in FIG. 4) notches 35 and a plurality of (four in FIG. 4) second vibration absorbing members 36.

The cover member main body 31 includes a first surface 31a that faces against the back surface of the display device main body 10, and a second surface 31b (see FIG. 1) on the opposite side from the first surface 31a. The cover member main body 31 is formed of a planar member. The cover member main body 31 is a resin member.

The cover member 30 is configured to cover the main body support member 20 so as to form a space S (see FIG. 3) extending or penetrating from the end portion in the Z1 direction to the end portion in the Z2 direction between the main body support member 20 and the cover member 30, and allow wiring 98 (see dotted line in FIG. 1) connected to the display device main body 10 to pass through the space S.

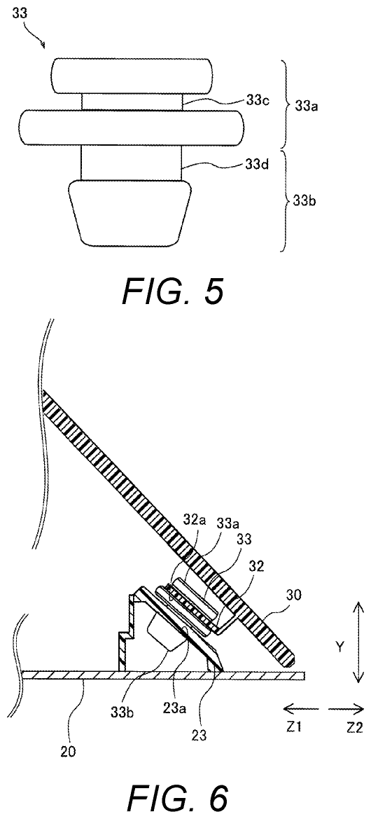

The first vibration absorbing member fixing portions 32 are configured to be able to fix upper parts 33a (see FIG. 5) of the first vibration absorbing members 33, respectively. The first vibration absorbing member fixing portions 32 are provided on the first surface 31a of the cover member main body 31. The first vibration absorbing member fixing portions 32 are provided at an end portion of the first surface 31a of the cover member main body 31 in the Z2 direction. The first vibration absorbing member fixing portions 32 are provided on both end portions of the cover member main body 31 in the X direction, respectively. The first vibration absorbing member fixing portions 32 includes second fitting holes 32a for fitting with and fixing the first vibration absorbing members 33, respectively. The first vibration absorbing member fixing portions 32 are provided with notches (not shown), respectively.

As shown in FIG. 5, the first vibration absorbing members 33 each include the upper part 33a and a lower part 33b. The first vibration absorbing members 33 are each provided with an annular first recess 33c at the upper part 33a. The first vibration absorbing members 33 are each provided with an annular second recess 33d at the lower part 33b. As shown in FIGS. 5 and 6, with the first vibration absorbing members 33, the annular first recesses 33c of the upper parts 33a are fitted with and fixed to the second fitting holes 32a of the first vibration absorbing member fixing portions 32, respectively. With the first vibration absorbing members 33, the annular second recesses 33d of the lower parts 33b are fitted with the first fitting holes 23a provided in the main body support member 20, respectively, and are detachably attached to the first fitting holes 23a, respectively. The first vibration absorbing members 33 are provided to the first vibration absorbing member fixing portions 32, respectively, that are provided on both end portions of the cover member main body 31 in the X direction, respectively.

The first vibration absorbing members 33 are made, for example, of an elastic body or material. The first vibration absorbing members 33 are, for example, a rubber member. By using the first vibration absorbing members 33 made of the above material, vibrations from the display device main body 10 via the main body support member 2 can be suppressed from being transmitted to the cover member 30, and the workability can be improved because tools are not required for fixing the main body support member 2 and the cover member 30. Specifically, in the illustrated embodiment, the first vibration absorbing members 33 serve as toolless fasteners for fixing the main body support member 2 and the cover member 30. In the illustrated embodiment, the first vibration absorbing members 33 independently formed as separate members from the cover member 30 and the main body support member 2. The first vibration absorbing members 33 are made of a material that is different from those of the cover member 30 and the main body support member 2. The first vibration absorbing members are made of an elastic material. The first vibration absorbing members each include the upper part 33 with the annular first recess 33c (e.g., first annular recess) and the lower part 33b with the annular second recess 33d (e.g., second annular recess).

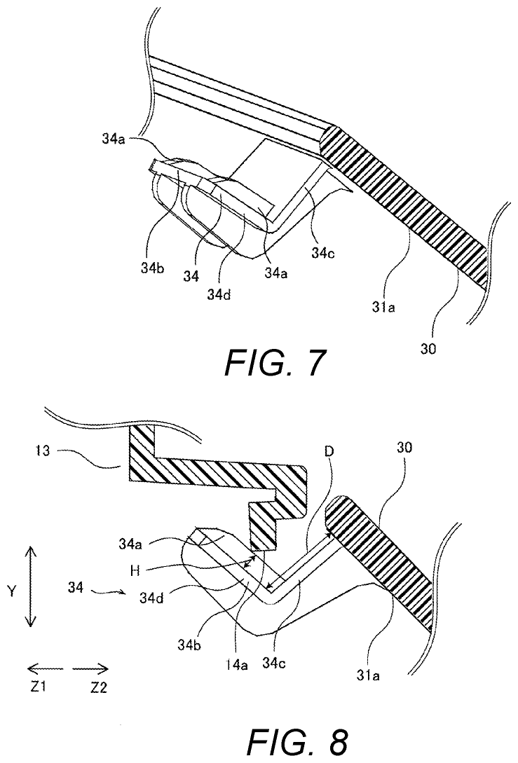

As shown in FIG. 7, the engagement pieces 34 are configured to be able to engage with the engagement holes 14 (see FIG. 3) formed in the rear cover 13 of the display device main body 10. The engagement pieces 34 are provided on the first surface 31a of the cover member main body 31. The engagement pieces 34 are provided on the end portion of the first surface 31a of the cover member main body 31 in the Z1 direction. The engagement pieces 34 are provided at both end portions of the cover member main body 31 in the X direction.

The engagement pieces 34 each include a plurality of (two in FIG. 7) ribs 34a and a rib connection portion 34b to which the ribs 34a are provided. The engagement pieces 34 engage with the rear cover 13 of the display device main body 10 in a state of being biased against the rear cover 13 of the display device main body 10.

Two ribs 34a are arranged relative to each other in the X direction at a rib forming portion 34d of the rib connection portion 34b. The ribs 34a have a convex shape extending toward the first surface 31a. The ribs 34a are configured to contact with inner peripheral edges 14a (see FIG. 8) of the engagement holes 14 of the rear cover 13, respectively.

The height H of the ribs 34a (see FIG. 8) is set such that the ribs 34a contact with the inner peripheral edges 14a of the engagement holes 14 while being biased in a state in which the ribs 34a contact with the inner peripheral edges 14a of the engagement holes 14 and are engaged with the engagement holes 14. In other words, as shown in FIG. 8, in this embodiment, the engagement pieces 34 that are disposed at a distance of D from the first surface 31a of the cover member main body 31 are disposed at a distance (D-H) at the portions of the ribs 34a. The engagement pieces 34 are deformed by the height H and engage with the engagement holes 14. The ribs 34a make linear contact with the inner peripheral edges 14a of the engagement holes 14, thereby the engagement pieces 34 being engaged with the engagement holes 14. The cover member 30 is fixed to the main body support member 20 in a non-contact state with respect to the rear cover 13, except for portions where the ribs 34a make linear contact with the inner peripheral edges 14a of the engagement holes 14.

The rib connection portion 34b includes a rising portion 34c and the rib forming portion 34d. The rising portion 34c is formed to protrude from the first surface 31a of the cover member 30. The rib forming portion 34d is connected to the rising portion 34c at one end and to extend substantially parallel to the first surface 31a of the cover member 30. The ribs 34a are formed at the rib forming portion 34d.

As shown in FIG. 4, the notches 35 include recesses formed by the cover member main body 31 being cut out. The notches 35 are formed at end portions of the cover member main body 31 in the Z1 direction and in the Z2 direction. The notch 35 formed at one end is configured to allow the wiring 98 (see FIG. 1) connected to the display device main body 10 to enter the space S, and the notch 35 formed at the other end is configured to allow the wring 98 connected to the display device main body 10 to exit outside from the space S.

The second vibration absorbing members 36 are provided separately from the first vibration absorbing members 33, and are arranged to be sandwiched between the cover member 30 and the main body support member 20 in a gap between the cover member 30 and the main body support member 20. Specifically, the second vibration absorbing members 36 are arranged to be sandwiched between the cover member 30 and the support portions 21 of the main body support member 20. The second vibration absorbing members 36 are affixed to the first sur surface 31a of the first vibration absorbing member 31. The second vibration absorbing members 36 are provided at end portions of the first surface 31a of the first vibration absorbing member 31 in the Z1 direction and in the Z2 direction. Two second vibration absorbing members 36 are provided at both end portions of the first surface 31a in the X direction, respectively, on one end portion in the Z1 direction, while two second vibration absorbing member 36 are provided at both end portions of the first surface 31a in the X direction, respectively, on the other end portion in the Z2 direction so as not to overlap with the first vibration absorbing members 33.

The second vibration absorbing members 36 have, for example, a plate shape. The second vibration absorbing members 36 are made, for example, of an elastic material. The second vibration absorbing members 36 are, for example, a rubber member. While the engagement pieces 34 of the cover member 30 are engaged with the engagement holes 14 of the rear cover 13, respectively, the engagement pieces 34 are pressed downward by the inner peripheral edges 14a of the engagement holes 14. The cover member 30 is suppressed from moving downward by the elasticity of the second vibration absorbing members 36.

The cover member 30 is fixed to the main body support member 20 via the first vibration absorbing members 33 in a non-contact state with respect to the main body support member 20. The cover member main body 31 is fixed to the main body support member 20 in a non-contact state with respect to the support portions 21 of the main body support member 20. The cover member 30 is also fixed to the main body support member 20 via the second vibration absorbing members 36 provided in the gap between the main body support member 20 and the cover member 30. The end portion of the cover member main body 31 in the Z2 direction is fixed to the main body support member 20 in a non-contact state with respect to the base portion 24 of the main body support member 20.

### (Attaching and Detaching Method of Cover Member and Main Body Support Member)

An attaching and detaching method of the cover member 30 and the main body support member 20 will be described.

Referring to FIGS. 6 and 8, the method of detaching the cover member 30 from the main body support member 20 will be explained. While the first vibration absorbing member fixing portions 32 of the cover member 30 and the fitting portions 23 of the main body support member 20 are fixed via the first vibration absorbing members 33, the end portion of the cover member 30 in the Z2 direction is moved away from the main body support member 20. As a result, the first vibration absorbing members 33 fixed to the first vibration absorbing member fixing portions 32 of the cover member 30 can be detached from the fitting portions 23 of the main body support member 20. In addition, when the first vibration absorbing members 33 fixed to the first vibration absorbing member fixing portions 32 of the cover member 30 are detached from the fitting portions 23 of the main body support member 20, a state in which the engagement pieces 34 are biased with respect to the rear cover 13 can be released. With this configuration, the engagement pieces 34 of the cover member 30 can be detached from the engagement holes 14 of the rear cover 13. As a result, the cover member 30 can be detached from the main body support member 20.

Next, the method of attaching the cover member 30 to the main body support member 20 will be explained. The engagement pieces 34 of the cover member 30 are inserted into the engagement holes 14 of the rear cover 13, respectively, such that the ribs 34a of the cover member 30 contact with the inner peripheral edges 14a of the engagement holes 14, respectively. While the ribs 34a of the cover member 30 contact with the inner peripheral edges 14a of the engagement holes 14, the first vibration absorbing members 33 fixed to the first vibration absorbing member fixing portions 32 of the cover member 30 are fitted with the fitting portions 23 of the main body support member 20, respectively. As mentioned above, the height H of the ribs 34a is set such that the ribs 34a contact with the inner peripheral edges 14a of the engagement holes 14 while being biased in a state in which the ribs 34a contact with the inner peripheral edges 14a of the engagement holes 14 and are engaged with the engagement holes 14. Therefore, the rib 34a contact with the inner peripheral edges 14a of the engagement holes 14 in a state of being biased. As a result, the cover member 30 can be attached to the main body support member 20.

### Effect of First Embodiment

In the first embodiment, the following effects can be obtained.

In the first embodiment, as described above, the first vibration absorbing members 33 are provided that are provided between the main body support member 20 and the cover member 30 to suppress the transmission of vibration between the main body support member 20 and the cover member 30. With this configuration, the vibration transmitted from the display device main body 10 to the main body support member 20 is absorbed by the first vibration absorbing members 33, and thus the transmission of the vibration to the cover member 30 can be suppressed. Therefore, the generation of interference noise between the main body support member 20 and the cover member 30 can be suppressed.

In the first embodiment, as described above, the first vibration absorbing members 33 fixedly couple the main body support member 20 and the cover member 30 in addition to suppressing the vibration. With this configuration, the first vibration absorbing members 33 can also be used as a fixing member for the main body support member 20 and the cover member 30. Therefore, the number of parts can be reduced, unlike the case in which a dedicated fixing member is separately provided to fix the main body support member 20 and the cover member 30.

In the first embodiment, as described above, the cover member 30 is fixed to the main body support member 20 via the first vibration absorbing members 33 in a non-contact state with respect to the main body support member 20. With this configuration, the generation of interference noise caused by contact portions between the main body support member 20 and the cover member 30 can be suppressed.

In the first embodiment, as described above, the main body support member 20 includes the support portions 21 that support the back surface of the display device main body 10, and the fitting portions 23 that are provided between the support portions 21 and fitted with the first vibration absorbing members 33, respectively. With this configuration, the generation of interference noise between the main body support member 20 and the cover member 30 can be easily suppressed, and the first vibration absorbing members 33 can be easily placed in the fitting portions 23 of the main body support member 20.

In the first embodiment, as described above, the cover member 30 is provided with the first vibration absorbing members 33 and the main body support member 20 is provided with the fitting portions 23 that are fitted with the first vibration absorbing members 33, respectively. The cover member 30 includes the engagement pieces 34 on the one end portions. The engagement pieces 34 engage with the back surface of the display device main body 10 in a state of being biased against the back surface of the display device main body 10. With this configuration, the cover member 30 can be fixed by contacting with the back surface of the display device main body 10 in a biased state. This can suppress the generation of interference noise caused by contact portions between the display device main body 10 and the cover member 30. Therefore, the generation of interference noise between the main body support member 20 and the cover member 30 can be suppressed and the generation of interference noise between the display device main body 10 and the cover member 30 can be suppressed.

In the first embodiment, as described above, the cover member 30 includes the engagement pieces 34 on the one end portion, which is on the back surface side, and the first vibration absorbing members 33 on the other end portion, which is on the opposite side from the back surface side. With this configuration, the generation of interference noise between the main body support member 20 and the cover member 30 can be easily suppressed, and the generation of interference noise between the display device main body 10 and the cover member 30 can be easily suppressed.

In addition, in the first embodiment, as described above, the display device main body 10 further includes the engagement holes 14 on the back surface that can engage with the engagement pieces 34, the engagement pieces 34 include the convex ribs 34a that contact with the inner peripheral edges 14a of the engagement holes 14, and the height of the ribs 34a is set such that the ribs 34a contact with the inner peripheral edges 14a of the engagement holes 14 while being biased in a state in which the engagement pieces 34 are engaged with the engagement holes 14. With this configuration, the cover member 30 can be fixed by contacting with the back surface of the display device main body 10 in a biased state, without increasing the number of parts, by means of the convex ribs 34a, unlike the case in which a dedicated biasing member is separately provided to apply a biasing force. Therefore, the increase in the number of parts can be suppressed.

In the first embodiment, as described above, the second vibration absorbing members 36 are further provided that are provided separately from the first vibration absorbing members 33 and are disposed in the gap between the cover member 30 and the main body support member 20 while being sandwiched between the cover member 30 and the main body support member 20. With this configuration, the generation of interference noise between the main body support member 20 and the cover member 30 can be more effectively suppressed. In addition, the cover member 30 can be fixed by contacting with the back surface of the display device main body 10 in a biased state, without further increasing the number of parts, unlike the case in which a dedicated biasing member is separately provided to apply a biasing force. Therefore, the increase in the number of parts can be suppressed.

### Second Embodiment

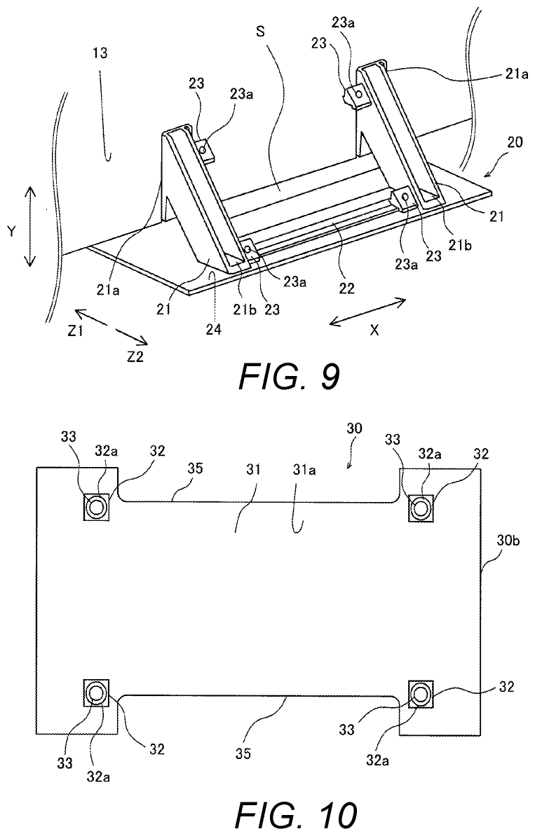

Referring now to FIG. 9, the configuration of a display device according to a second embodiment that comprises the display device main body 10, the main body support member 20 and the cover member 30 will be explained. Unlike the first embodiment in which the first vibration absorbing members 33 are provided at the other end portion of the cover member 30 (the end portion in the Z2 direction), the fitting portions 23 with which the first vibration absorbing members 33 are fitted are provided at the other end portion of the main body support member 20, the engagement pieces 34 are provided on the one end portion (the end portion in the Z1 direction) of the cover member 30, the engagement holes 14 that are engaged with the engagement pieces 34 are provided on the back surface of the display device main body 10, and the second vibration absorbing members 36 are provided between the main body support member 20 and the cover member 30, in the second embodiment, the engagement pieces 34 of the cover member 30 and the engagement holes 14 on the back surface of the display device main body 10 are not provided, the second vibration absorbing members 36 are not provided, the first vibration absorbing members 33 are provided on both the one end portion (the end portion in the Z1 direction) and the other end portion (the end portion in the Z2 direction) of the cover member 30, and the fitting portions 23 with which the first vibration absorbing members 33 are fitted are provided to the main body support member 20. The display device main body 10 has the identical configuration to the display device main body 10 of the first embodiment, except that the display device main body 10 is not provided with the engagement holes 14 on the back surface and is not engaged with the cover member 30.

As shown in FIG. 10, the first vibration absorbing members 33 are provided in both end portions of the cover member 30 in the Z1 direction and in the Z2 direction, and the fitting portions 23 with which the first vibration absorbing members 33 are fitted, respectively, are provided to the main body support member 20. The cover member 30 is fixed to the main body support member 20 in a state in which the first vibration absorbing members 33 are fitted with the fitted portions 23.

The cover member 30 is provided with the first vibration absorbing member fixing portions 32 to which the first vibration absorbing members 33 are fixed. The first vibration absorbing member fixing portions 32 are provided to the first surface 31a of the cover member main body 31. The first vibration absorbing member fixing portions 32 are provided to both end portions of the first surface 31a of the cover member main body 31 in the Z1 direction and in the Z2 direction. The first vibration absorbing member fixing portions 32 are provided at both end portions of the first surface 31a in the X direction, respectively, on one end portion in the Z1 direction, and are provided at both end portions of the first surface 31a in the X direction, respectively, on the other end portion in the Z2 direction. The first vibration absorbing members 33 are provided to the first vibration absorbing member fixing portions 32, respectively.

As shown in FIG. 9, the main body support member 20 is provided with the fitting portions 23 with which the first vibration absorbing members 33 that are provided to the cover member 30 are fitted. The fitting portions 23 are provided at one end portions of the support portions 21 and at the other end portions of the support portions 21, respectively. The fitting portions 23 are provided adjacent to opposite surfaces of the support portions 21, respectively. In this embodiment, a total of four first vibration absorbing members 33 are provided on both one end portion and the other end portion of the cover member 30, and a total of four fitting portions 23 with which the first vibration absorbing members 33 are fitted, respectively, are provided to the main body support member 20. As a result, the cover member 30 is fixed to the main body support member 20 via the first vibration absorbing members 33 in a state of being hollow with respect to the main body support member 20.

Other configurations of the second embodiment are the same as the first embodiment above.

### Effect of Second Embodiment

In the second embodiment, as described above, the first vibration absorbing members 33 are provided on both the one end portion of the cover member 30 that is on the back surface side and the other end portion that is on the opposite side from the back surface side, the fitting portions 23 that are fitted with the first vibration absorbing members 33, respectively, are provided on the main body support member 20, and the cover member 30 is fixed to the main body support member 20 in a state in which the first vibration absorbing members 33 are fitted with the fitting portions 23, respectively. With this configuration, the cover member 30 can be fixed to the main body support member 20 by fitting the first vibration absorbing members 33 to the fitting portions 23, respectively, and thus the generation of interference noise between the main body support member 20 and the cover member 30 can be easily suppressed.

Other effects of the second embodiment are the same as those of the first embodiment.

### MODIFICATION EXAMPLES

The embodiments disclosed here should be considered in all respects to be illustrative and not restrictive. The scope of the invention is indicated by the claims, not by the description of the embodiments described above, and furthermore includes all changes (modification examples) within the meaning and scope equivalent to the claims.

For example, in the first and second embodiments above, an example is illustrated in which the first vibration absorbing members 33 are provided to one of the cover member 30 and the main body support member 20 and the fitting portions 23 with which the first vibration absorbing members 33 are fitted are provided to the other one of the cover member 30 and the main body support member 20, but this invention is not limited to this. For example, the cover member 30 can further include an attachment portion for attaching a function extension device connectable with the display device main body 10.

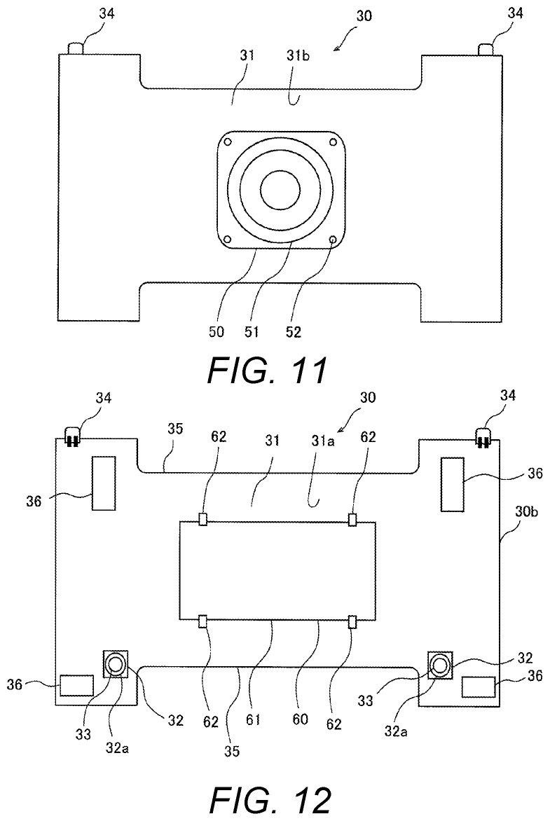

As shown in FIG. 11, the function extension device can be, for example, a speaker device 51. The cover member 30 can include a speaker attachment portion 50 for attaching the speaker device 51 connectable to the display device main body 10, and to hold the speaker device 51 toward the opposite side of the cover member 30 from the main body support member 20.

The speaker attachment portion 50 is, for example, provided to the second surface 31b of the cover member main body 31. The speaker device 51 is attached and fixed to the cover member 30 via fixing members 52, such as screws, at the speaker attachment portion 50. The speaker device 51 is, for example, an active speaker. The active speaker is a speaker with an amplifier built into a speaker housing. The speaker device 51 is wired to a terminal (not shown) provided on the back surface of the display device main body 10 and is supplied with power from the display device main body 10. In this modified example, one speaker device 51 is provided, but the number of speaker devices 51 is not limited.

The speaker device 51 can wirelessly communicate with the display device main body 10. The wireless communication is performed by Bluetooth (registered trademark) communication or Wi-Fi (registered trademark) communication, etc. The speaker device 51 can perform wired communication instead of wireless communication with the display device main body 10. The speaker device 51 can be used as a speaker for audio output of the display device main body 10 via the wireless communication with the display device main body 10. The speaker device 51 can output audio based on an operation relative to an operation screen (not shown) for the speaker device 51 that is displayed on the display 11 of the display device main body 10.

The speaker device 51 can be used as a speaker for audio output from an external device via wireless communication with the external device. The speaker device 51 can output both audio from the display device main body 10 and audio input from the external device.

In the above modification example, the cover member 30 further includes the speaker attachment portion 51 for attaching the speaker device 51 connectable to the display device main body 10, and the speaker attachment portion 50 holds the speaker device 51 toward the opposite side of the cover member 30 from the main body support member 20. With this configuration, the vibration transmitted from the speaker device 51 attached to the speaker attachment portion 50 to the cover member 30 can be suppressed from being transmitted to the main body support member 20 by being absorbed by the first vibration absorbing members 33. Therefore, the generation of interference noise between the main body support member 20 and the cover member 30 caused by the speaker device 51 attached to the speaker attachment portion 50 can be easily suppressed.

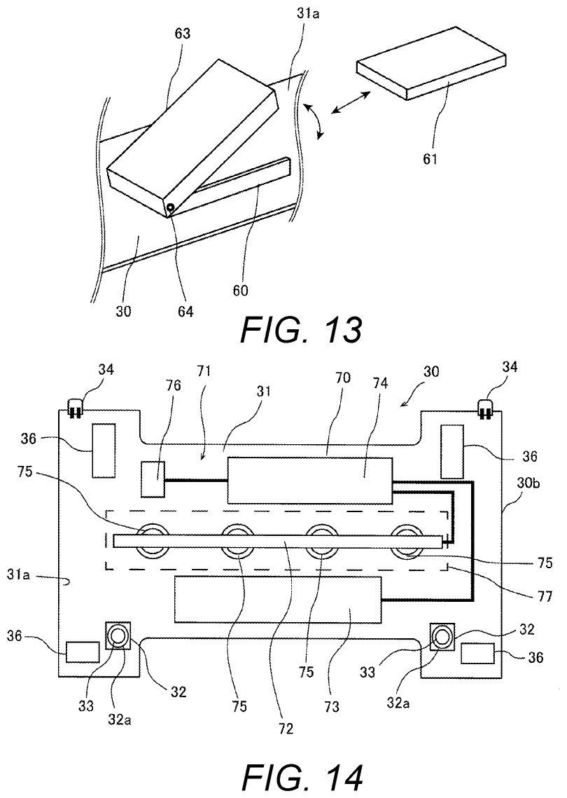

As shown in FIGS. 12 and 13, the function extension device can be, for example, a storage device 61. The cover member 30 further includes a storage device attachment portion 60 for attaching the storage device 61 connectable to the display device main body 10, and the storage device attachment portion 60 is provided on the surface of the cover member 30 facing toward the main body support member 20. The storage device 61 includes, for example, a storage medium (a hard disk drive). The storage device 61 and the display device main body 10 can be connected via cables or wirings, such as USB (Universal Serial Bus) interface and SATA (Serial Advanced Technology Attachment), PCIe (Peripheral Component Interconnect-Express), etc. The storage device 61 and the display device main body 10 can also be connected by an HDMI (registered trademark) (not shown) cable so that information can be exchanged.

As shown in FIG. 12, the storage device attachment portion 60 is, for example, provided to the first surface 31a of the cover member main body 31. The storage device attachment portion 60 can, for example, be provided with a plurality of hooks 62 to which the storage device 61 is attached and fixed. In this modification example, four hooks 62 are provided to hold the four corners of the storage device 61. The number of the hooks 62 is not limited to four. Since the hooks 62 are provided to the storage device attachment portion 60, no tools are required for attaching and detaching work of the storage device 61 to and from the cover member 30.

As shown in FIG. 13, the storage device attachment portion 60 can, for example, be provided with a housing 63 for accommodating the storage device 61. Specifically, the storage device 61 can be accommodated inside the housing 63. The housing 63 can open and close via a hinge 64. Since the housing 63 that can open and close is provided to the storage device attachment portion 60, no tools are required for attaching and detaching work of the storage device 61 to and from the cover member 30.

The attachment structure for the storage device 61 provided to the storage device attachment portion 60 is not specifically limited, as long as the attachment structure can attach and fix the storage device 61 and make the attaching and detaching work of the storage device 61 to and from the cover member 30 easier. Furthermore, a conversion circuit (not shown) for connecting the storage device 61 and the display device main body 10 that have different connection standards can be provided to the storage device 61, or can be provided to the cover member 30.

In the above modification embodiment, the cover member 30 further includes the storage device attachment portion 60 for attaching the storage device 61 connectable to the display device main body 10, and the storage device attachment portion 60 is provided to the surface of the cover member 30 facing with the main body support member 20. With this configuration, the vibration transmitted from the rear frame 12 of the display device main body 10 to the main body support member 20, which is caused by the speaker (not shown) provided to the display device main body 10, for example, can be suppressed from being transmitted to the cover member 30 by being absorbed by the first vibration absorbing member 30, and thus the transmission of vibration to the storage device 61 attached to the cover member 30 can be suppressed.

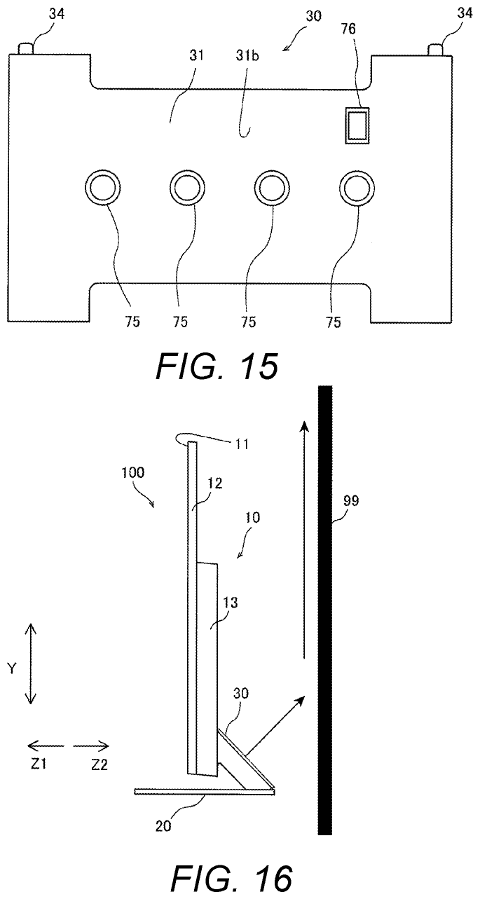

As shown in FIGS. 14 and 15, the function expansion device can be, for example, a light source 72. The cover member 30 further includes a light source attachment portion 70 for attaching the light source 72 connectable to the display device main body 10, and the light source attachment portion 70 holds the light source 72 toward the opposite side of the cover member 30 from the main body support member 20. As also shown in FIG. 16, the cover member 30 is disposed at an angle with respect to the vertical direction, and thus the light source 72 attached to the cover member 30 can project light on an interior wall 99.

The light source attachment portion 70 is, for example, provided to the first surface 31a of the cover member main body 31. A light source device 71 that includes the light source 72, a battery 73 and a control board 74 is attached to the light source attachment portion 70. The cover member 30 is provided with a plurality of windows 75 for guiding the light from the light source 72 provided to the first surface 31a toward the second surface 31b. Although four windows 75 are provided in this modification example, the number of the windows 75 is not limited. In addition, the second surface 31b of the cover member 30 is provided with a switch 76 that can be manually switched for turning on and off the light source 72. The light source device 71 is wired to the display device main body 10.

The light source 72 is, for example, an LED light bar. In addition, the back surface of the light source 72 can be provided with a heat sink 77 (see dotted line in FIG. 14) made of a material with a high thermal conductivity, such as aluminum, for radiating the heat generation from the light source 72. The light source 72 and the cover member 30 can be fixed by adhesion using glue or tape, or can be fixed by screwing or fitting with hooks or other means. The battery 73 can be charged and supplied with power from the display device main body 10.

The control board 74 includes a CPU (Central Processing Unit), ROM (Read Only Memory), and RAM (Random Access Memory), etc., and is configured as a control unit or an electronic controller that controls the entire light source device 71. The control unit is configured to check the charge level of the battery 73 and to charge the battery 73 when the charge level is below a predetermined threshold. The control unit is also configured to control the brightness, luminance, and color scheme of the light source 72 while the light source 72 is turning on.

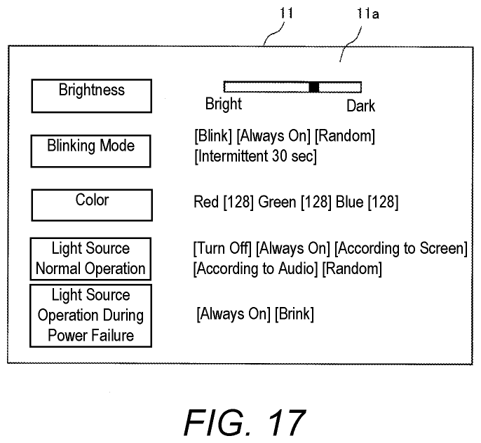

the lighting control of the light source 72 can be performed based on an operation relative to a setting screen 11a for lighting, as shown in FIG. 17, which is displayed on the display 11 of the display device main body 10. FIG. 17 is an example of the setting screen 11a for lighting control of the light source 72. The setting screen 11a displays items (menus) related to “Brightness,” “Blinking Mode,” “Color,” “Light Source Normal Operation,” and “Light Source Operation During Power Failure.” The lighting control of the light source 72 can be performed by the user's selection or by the user's input of values relative to each item. In the “Light Source Normal Operation”, “According to Screen” means a setting in which the lighting brightness of the light source 72 is changed according to the color displayed on the display 11 of the display device main body 10. In addition, “According to Audio” means a setting for turning the light on relatively brightly when the audio level from the display device main body 10 is relatively high (loud), and turning the light on relatively darkly when the audio level is relatively low (quiet).

“Light Source Operation During Power Failure” means a setting of the lighting control of the light source 72 during a power failure. Specifically, the control unit determines that a power failure has occurred when the power supply of the display device main body 10 is ON or OFF and the voltage of the commercial power source is below a predetermined value. “Light Source Operation During Power Failure” means a setting of the lighting control of the light source 72 when the control unit determines that a power failure has occurred.

When “Always On” is set in “Light Source Operation During Power Failure” and the control unit determines that a power failure has occurred, the light source 72 turns on by the power supply from the battery 73. When “Blinking” is set in “Light Source Operation During Power Failure” and the control unit determines that a power failure has occurred, the light source 72 blinks using the power supply from the battery 73. With this configuration, the user can recognize the location of the light source 72 that turns on or blinks in the event of a power failure, and the cover member 30 to which the light source 72 is attached can be used as a portable lighting device by detaching the cover member 30 from the main body support member 20. Since the cover member 30 is provided with the switch 76, the light source 72 can be switched on and off manually as needed.

In the above modification example, the cover member 30 further includes the light source attachment portion 70 for attaching the light source 72 connectable to the display device main body 10, and the light source attachment portion 70 holds the light source 72 toward the opposite side of the cover member 30 from the main body support member 20. With this configuration, a lighting environment by the light source 72 can be provided, and the cover member 30 can be used as a portable lighting device by detaching the cover member 30 to which the light source 72 is attached from the main body support member 20.

In the first and second embodiments above, an example is shown in which the first vibration absorbing members 33 are provided to the cover member 30 and the fitting portions 23 that are fitted with the first vibration absorbing members 33, respectively, are provided to the main body support member 20, but this invention is not limited to this. For example, the fitting portions 23 can be provided to the cover member 30 and the first vibration absorbing members 33 can be provided at positions of the main body support member 20 corresponding to the positions where the fitting portions 23 are provided.

In the first embodiment above, an example is shown in which two engagement pieces 34 are provided at one end portion of the cover member 30, and two engagement holes 14 that can be engaged with the engagement pieces 34 are provided on the back surface of the display device main body 10, but this invention is not limited to this. For example, the number of the engagement pieces 34 provided at the one end portion of the cover member 30 can be one, or three or more. The number of the engagement holes 14 provided on the back surface of the display device main body 10 can be as many as the number of the engagement pieces 34 provided to the cover member 30.

In the first embodiment above, an example is shown in which two first vibration absorbing members 33 are provided on the other end portion of the cover member 30 and two fitting portions 23 that can be fitted with the first vibration absorbing members 33 are provided to the main body support member 20, but this invention is not limited to this. For example, the number of the first vibration absorbing members 33 provided at the other end portion of the cover member 30 can be one, or three or more. The number of the fitting portions 23 provided to the main body support member 20 can be as many as the number of the first vibration absorbing members 33 provided to the cover member 30.

In the second embodiment above, an example is shown in which two first vibration absorbing members 33 are provided at the one end portion of the cover member 30, two first vibration absorbing members 33 are provided at the other end portion of the cover member 30, and four fitting portions 23 that can be fitted with the first vibration absorbing members 33 are provided to the main body support member 20, but this invention is not limited to this. For example, the number of the first vibration absorbing members 33 provided at the one end portion of the cover member 30 can be one, or three or more. The number of the first vibration absorbing members 33 provided at the other end portion of the cover member 30 can be one, or three or more. The number of the fitting portions 23 provided to the main body support member 20 can be as many as the number of the first vibration absorbing members 33 provided to the cover member 30.

In the first and second embodiments above, an example is shown in which the first vibration absorbing members 33 that are provided between the main body support member 20 and the cover member 30 and fixes the main body support member 20 and the cover member 30 each include the lower portion 33b and the upper portion 33a, but this invention is not limited to this. For example, as long as the upper portions 33a of the first vibration absorbing members 33 can be fixed to fixing portions of the cover member 30 and the lower portions 33b of the first vibration absorbing members 33 can be fitted into and out of fitting portions of the main body support member 20, the attaching and detaching structure between the main body support member 20 and the cover member 30 via the first vibration absorbing members 33 is not specifically limited.

In the first and second embodiments, an example is shown in which two ribs 34a are provided to each of the engagement pieces 34, but this invention is not limited to this. For example, the number of the ribs 34a of each of the engagement pieces 34 can be one, or three or more.

In the first and second embodiments above, an example is shown in which the notches 35 are provided to the cover member 30, but this invention is not limited to this. For example, as long as the wiring 98 connected to the display device main body 10 can pass through the space S formed by the cover member 30 and the support portions 21 of the main body support member 20 so as to penetrate from the one end portion that is on the back surface side of the display device main body 10 to the other end portion, the cover member 30 may not be provided with the notches 35.

In the first embodiment, an example is shown in which the second vibration absorbing members 36 are disposed by being sandwiched between the cover member 30 and the main body support member 20, but this invention is not limited to this. For example, the second vibration absorbing members 36 may not be provided. The number and disposed location of the second vibration absorbing members 36 are also not limited.

In the first embodiment, an example is shown in which the first vibration absorbing members 33 fix the main body support member 20 and the cover member 30, but this invention is not limited to this. For example, the main body support member 20 and the cover member 30 can be fixed via members different from the first vibration absorbing members 33.

(1) In view of the state of the known technology, a display device according to a first aspect of this disclosure comprises a display device main body including a display, a main body support member that supports a back surface of the display device main body, a cover member that covers the main body support member so as to form a space extending from one end portion of the cover member, which is closer to the back surface than the other end portion to the other end portion between the main body support member and the cover member and allow wiring connected to the display device main body to pass through the space, and at least one first vibration absorbing member that is provided between the main body support member and the cover member to suppress transmission of vibration between the main body support member and the cover member.

The display device according to the first aspect of this disclosure has, as described above, the at least one first vibration absorbing member that is provided between the main body support member and the cover member to suppress the transmission of vibration between the main body support member and the cover member. With this configuration, the vibration transmitted from the display device main body to the main body support member can be absorbed by the at least one first vibration absorbing member, and thus the transmission of the vibration to the cover member can be suppressed. Therefore, the generation of interference noise between the main body support member and the cover member can be suppressed.

(2) In accordance with a preferred embodiment according to the display device mentioned above, the at least one first vibration absorbing member fixedly couples the main body support member and the cover member. With this configuration, the at least one first vibration absorbing member can also be used as a fixing member for the main body support member and the cover member. Therefore, the number of parts can be reduced, unlike the case in which a dedicated fixing member is separately provided to fix the main body support member and the cover member.

(3) In accordance with a preferred embodiment according to any one of the display devices mentioned above, the cover member is fixed to the main body support member via the at least one first vibration absorbing member in a non-contact state with respect to the main body support member. With this configuration, the generation of interference noise caused by contact portions between the main body support member and the cover member can be suppressed.

(4) In accordance with a preferred embodiment according to any one of the display devices mentioned above, the main body support member includes a pair of support portions that support the back surface of the display device main body, and at least one fitting portion that is provided between the support portions and is fitted with the at least one first vibration absorbing member. With this configuration, the generation of interference noise between the main body support member and the cover member can be easily suppressed, and the at least one first vibration absorbing member can be easily placed in the at least one fitting portion of the main body support member.

(5) In accordance with a preferred embodiment according to any one of the display devices mentioned above, one of the cover member and the main body support member is provided with the at least one first vibration absorbing member and the other one of the cover member and the main body support member is provided with at least one fitting portion that is fitted with the at least one first vibration absorbing member.

(6) In accordance with a preferred embodiment according to any one of the display devices mentioned above, the cover member includes at least one engagement piece on the one end portion, the at least one engagement piece engaging with the back surface of the display device main body in a state of being biased against the back surface of the display device main body.

With this configuration, the cover member can be fixed by contacting with the back surface of the display device main body in a biased state. This can suppress the generation of interference noise caused by contact portions between the display device main body and the cover member. Therefore, the generation of interference noise between the main body support member and the cover member can be suppressed and the generation of interference noise between the display device main body and the cover member can be suppressed.

(7) In accordance with a preferred embodiment according to any one of the display devices mentioned above, the at least one engagement piece of the cover member includes a plurality of the engagement pieces on the one end portion, and the at least one first vibration absorbing member includes a plurality of first vibration absorbing members provided on the other end portion. With this configuration, the generation of interference noise between the main body support member and the cover member can be easily suppressed, and the generation of interference noise between the display device main body and the cover member can be easily suppressed.

(8) In accordance with a preferred embodiment according to any one of the display devices mentioned above, the display device main body further includes at least one engagement hole on the back surface that engages with the at least one engagement piece.

(9) In accordance with a preferred embodiment according to any one of the display devices mentioned above, the at least one engagement piece includes a convex rib that contacts with an inner peripheral edge of the at least one engagement hole, and the rib has a height such that the rib contacts with the inner peripheral edge of the at least one engagement hole while being biased in a state in which the at least one engagement piece is engaged with the at least one engagement hole.

With this configuration, the cover member can be fixed by contacting with the back surface of the display device main body in a biased state, without increasing the number of parts, by means of the convex rib, unlike the case in which a dedicated biasing member is separately provided to apply a biasing force. Therefore, the increase in the number of parts can be suppressed.

(10) In accordance with a preferred embodiment according to any one of the display devices mentioned above, the at least one first vibration absorbing member includes a plurality of first vibration absorbing members provided on both the one end portion and the other end portion, the main body support member is provided with a plurality of fitting portions that are fitted with the first vibration absorbing members, respectively, and the cover member is fixed to the main body support member in a state in which the first vibration absorbing members are fitted with the fitting portions, respectively.

(11) In accordance with a preferred embodiment according to any one of the display devices mentioned above, the cover member is provided with a plurality of fitting portions on both the one end portion and the other end portion, the at least one first vibration absorbing member includes a plurality of the first vibration absorbing members provided at positions on the main body support member corresponding to positions of the fitting portions, and the cover member is fixed to the main body support member in a state in which the first vibration absorbing members are fitted with the fitting portions, respectively.

With this configuration, the cover member can be fixed to the main body support member by fitting the first vibration absorbing members to the fitting portions, respectively, and thus the generation of interference noise between the main body support member and the cover member can be easily suppressed.

(12) In accordance with a preferred embodiment according to any one of the display devices mentioned above, the display device further comprises, at least one second vibration absorbing member that is provided separately from the at least one first vibration absorbing member and is disposed between the cover member and the main body support member so as to be sandwiched between the cover member and the main body support member. With this configuration, the generation of interference noise between the main body support member and the cover member can be more effectively suppressed. In addition, the cover member can be fixed by contacting with the back surface of the display device main body in a biased state, without further increasing the number of parts, unlike the case in which a dedicated biasing member is separately provided to apply a biasing force. Therefore, the increase in the number of parts can be suppressed.

(13) In accordance with a preferred embodiment according to any one of the display devices mentioned above, the cover member further includes a speaker attachment portion for attaching a speaker device that is connectable with the display device main body, and the speaker attachment portion is configured to hold the speaker device toward an opposite side of the cover member from the main body support member. With this configuration, vibration transmitted from the speaker device attached to the speaker attachment portion to the cover member can be suppressed from being transmitted to the main body support member by being absorbed by the at least one first vibration absorbing member. Therefore, the generation of interference noise between the main body support member and the cover member caused by the speaker device attached to the speaker attachment portion can be easily suppressed.

(14) In accordance with a preferred embodiment according to any one of the display devices mentioned above, the cover member further includes a storage device attachment portion for attaching a storage device that is connectable to the display device main body, and the storage device attachment portion is provided on a surface of the cover member facing toward the main body support member. With this configuration, vibration transmitted from a rear frame of the display device main body to the main body support member, which is caused by a speaker provided to the display device main body, for example, can be suppressed from being transmitted to the cover member by being absorbed by the at least one first vibration absorbing member, and thus the transmission of vibration to the storage device attached to the cover member can be suppressed. Therefore, defects in the storage device caused by the vibration transmitted from the display device main body can be suppressed.

(15) In accordance with a preferred embodiment according to any one of the display devices mentioned above, the cover member further includes a light source attachment portion for attaching a light source that is connectable with the display device main body, and the light source attachment portion is configured to hold the light source toward an opposite side of the cover member from the main body support member. With this configuration, a lighting environment by the light source can be provided, and the cover member can be used as a portable lighting device by detaching the cover member to which the light source is attached from the main body support member.

(16) In accordance with a preferred embodiment according to any one of the display devices mentioned above, the at least one first vibration absorbing member is independently formed as a separate member from the cover member and the main body support member.

(17) In accordance with a preferred embodiment according to any one of the display devices mentioned above, the at least one first vibration absorbing member is made of a material that is different from those of the cover member and the main body support member.

(18) In accordance with a preferred embodiment according to any one of the display devices mentioned above, the at least one first vibration absorbing member is made of an elastic material.

(19) In accordance with a preferred embodiment according to any one of the display devices mentioned above, the at least one first vibration absorbing member includes an upper part with a first annular recess and a lower part with a second annular recess.

(20) In accordance with a preferred embodiment according to any one of the display devices mentioned above, the main body support member includes a pair of support portions that extend downward as moving away from the back surface of the display device main body, and the cover member is attached to the main body support member such that the cover member is oriented along support portions.

According to the present disclosure, as described above, it is possible to provide a display device capable of suppressing the generation of interference noise between the main body support member and the cover member.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

As used herein, the following directional terms “forward”, “rearward”, “front”, “rear”, “up”, “down”, “above”, “below”, “upward”, “downward”, “top”, “bottom”, “side”, “vertical”, “horizontal”, “perpendicular” and “transverse” as well as any other similar directional terms refer to those directions of a display device in an upright position on a horizontal surface. Accordingly, these directional terms, as utilized to describe the display device should be interpreted relative to a display device in an upright position on a horizontal surface. The terms “left” and “right” are used to indicate the “right” when referencing from the right side as viewed from the front side of the display device, and the “left” when referencing from the left side as viewed from the front side of the display device.

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of equal to or more than two choices” if the number of its choices is equal to or more than three. Also, the term “and/or” as used in this disclosure means “either one or both of”.

The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A display device, comprising:
a display device main body that includes a display;
a main body support member that supports a back surface of the display device main body;
a cover member that covers the main body support member so as to form a space extending from one end portion of the cover member, which is closer to the back surface than the other end portion, to the other end portion between the main body support member and the cover member and allow wiring connected to the display device main body to pass through the space; and
at least one first vibration absorbing member that is provided between the main body support member and the cover member to suppress transmission of vibration between the main body support member and the cover member.

2. The display device according to claim 1, wherein
the at least one first vibration absorbing member fixedly couples the main body support member and the cover member.

3. The display device according to claim 1, wherein
the cover member is fixed to the main body support member via the at least one first vibration absorbing member in a non-contact state with respect to the main body support member.

4. The display device according to claim 1, wherein
the main body support member includes a pair of support portions that support the back surface of the display device main body, and at least one fitting portion that is provided between the support portions and is fitted with the at least one first vibration absorbing member.

5. The display device according to claim 1, wherein
one of the cover member and the main body support member is provided with the at least one first vibration absorbing member and the other one of the cover member and the main body support member is provided with at least one fitting portion that is fitted with the at least one first vibration absorbing member.

6. The display device according to claim 5, wherein
the cover member includes at least one engagement piece on the one end portion, the at least one engagement piece engaging with the back surface of the display device main body in a state of being biased against the back surface of the display device main body.

7. The display device according to claim 6, wherein
the at least one engagement piece of the cover member includes a plurality of engagement pieces on the one end portion, and
the at least one first vibration absorbing member includes a plurality of the first vibration absorbing members provided on the other end portion.

8. The display device according to claim 6, wherein
the display device main body further includes at least one engagement hole on the back surface that engages with the at least one engagement piece.

9. the display device according to claim 8, wherein
the at least one engagement piece includes a convex rib that contacts with an inner peripheral edge of the at least one engagement hole, and
the rib has a height such that the rib contacts with the inner peripheral edge of the at least one engagement hole while being biased in a state in which the at least one engagement piece is engaged with the at least one engagement hole.

10. The display device according to claim 1, wherein
the at least one first vibration absorbing member includes a plurality of first vibration absorbing members provided on both the one end portion and the other end portion,
the main body support member is provided with a plurality of fitting portions that are fitted with the first vibration absorbing members, respectively, and
the cover member is fixed to the main body support member in a state in which the first vibration absorbing members are fitted with the fitting portions, respectively.

11. The display device according to claim 1, wherein
the cover member is provided with a plurality of fitting portions on both the one end portion and the other end portion,
the at least one first vibration absorbing member includes a plurality of the first vibration absorbing members provided at positions on the main body support member corresponding to positions of the fitting portions, and
the cover member is fixed to the main body support member in a state in which the first vibration absorbing members are fitted with the fitting portions, respectively.

12. The display device according to claim 1, further comprising
at least one second vibration absorbing member that is provided separately from the at least one first vibration absorbing member and is disposed between the cover member and the main body support member so as to be sandwiched between the cover member and the main body support member.

13. The display device according to claim 1, wherein
the cover member further includes a speaker attachment portion for attaching a speaker device that is connectable with the display device main body, and
the speaker attachment portion is configured to hold the speaker device toward an opposite side of the cover member from the main body support member.

14. The display device according to claim 1, wherein
the cover member further includes a storage device attachment portion for attaching a storage device that is connectable to the display device main body, and
the storage device attachment portion is provided on a surface of the cover member facing toward the main body support member.

15. The display device according to claim 1, wherein
the cover member further includes a light source attachment portion for attaching a light source that is connectable to the display device main body, and
the light source attachment portion is configured to hold the light source toward an opposite side of the cover member from the main body support member.

16. The display device according to claim 1, wherein
the at least one first vibration absorbing member is independently formed as a separate member from the cover member and the main body support member.

17. The display device according to claim 1, wherein
the at least one first vibration absorbing member is made of a material that is different from those of the cover member and the main body support member.

18. The display device according to claim 17, wherein
the at least one first vibration absorbing member is made of an elastic material.

19. The display device according to claim 1, wherein
the at least one first vibration absorbing member includes an upper part with a first annular recess and a lower part with a second annular recess.

20. The display device according to claim 1, wherein
the main body support member includes a pair of support portions that extend downward as moving away from the back surface of the display device main body, and
the cover member is attached to the main body support member such that the cover member is oriented along the support portions.
